(19) United States
(12) Patent Application Publication
(10) Pub. No.: US 2001/0010042 A1
(43) Pub. Date: Jul. 26, 2001

(54) System for providing user-selected information through internet

(76) Inventor: Ki-Ho Oh, Seoul (KR)

Correspondence Address: ROBERT E. BUSHNELL, 1522 K STREET NW, SUITE 300, WASHINGTON, DC, 200051202

(21) Appl. No.: 09/768,256

(22) Filed: Jan. 25, 2001

(30) Foreign Application Priority Data
Jan. 26, 2000 (KR) 2000-3617

(51) Int. Cl. G06F 17/60

(52) U.S. Cl. 705/14; 705/26; 705/35

(57) ABSTRACT

A user-selected information providing system has an additional service providing server for providing an additional service about a specific information, a user-selected information providing server linked to the additional service providing server through Internet, for providing by synthesizing a basic information related to a user information, a user-selected information and the additional service provided by the additional service providing server, and a terminal apparatus receiving the basic information, the user-selected information and the additional service by connecting with the user-selected information providing server through the Internet. Further the user-selected information providing server gives a premium depending on the number of the terminal apparatus purchased by users to the terminal apparatus manufacturing company, and receives a premium depending on the number of the users receiving the additional information from the user-selected information providing server.

### CLAIM OF PRIORITY

This application makes reference to, incorporates the same herein, and claims all benefits accruing under 35 U.S.C. §119 from my application INTERNET SERVICE SYSTEM FOR PROVIDING DESIGNED INFORMATION filed with the Korean Industrial Property Office on Jan. 26, 2000 and there duly assigned U.S. Ser. No. 3617/2000.

### BACKGROUND OF THE INVENTION

1. Technical Field of the Invention

The present invention relates to a system providing information to a user through the Internet, and, more particularly, relates to a system for quickly providing to the user the information which a user has selected, including services the user selected.

2. Related Art

The Internet is known as a passport which human beings living in a new millennium should have. The web is one of the critical factors which make the Internet popular.

The web comprises a web server for providing information and a web client, or web browser for receiving the information from the web server. The web server and the web client communicate each other by using an Internet protocol, e.g., Hyper Text Transfer Protocol (HTTP), and transfer documents in mark up language form, e.g., Hypertext Markup Language (HTML).

Recently, based on such a Internet web, various services such as an electronic business deal, an electronic news, e.g., an electronic newspaper, and a cyber stock deal are provided. Since, through the Internet, the user is able to do with ease works which have actually been done, become easily serviced things which they were executing themselves, the Internet service is rapidly becoming the most important business.

Further, the conventional web clients are in personal computer (PC) category such as a notebook computer and a desktop computer. However, nowadays the Internet service could be provided through various platforms in non-PC category such as a web phone, a web TV, a personal digital assistants (PDA) and a wireless phone.

The advertisement and marketing techniques through the Internet have been practiced in various ways. Among them, the most popular technique is to pay cyber money to a user whenever the user clicks an advertisement message. That is, a company managing a web server independently invites a banner advertisement from an advertisement server and designates the banner advertisement in the home page which the company manages in specific period.

However, in case of the above method, it take long time to load the excessive advertisements in the aspect of an user who is not interested in the advertisements.

Further, the user may less like a specific site because he must see an advertisement which he does not want in the site.

### SUMMARY OF THE INVENTION

It is, therefore, a primary object of the invention to provide a system for supplying to a user only the information that the user wants to receive.

A user-selected information providing system comprises: an additional service providing server for providing an additional service about a specific information, a user-selected information providing server linked to the additional service providing server through Internet, for providing by synthesizing a basic information related to a user information, a user-selected information and the additional service provided by the additional service providing server, and a terminal apparatus receiving the basic information, the user-selected information and the additional service by connecting with the user-selected information providing server through the Internet.

Further the user-selected information providing server gives a premium depending on the number of the terminal apparatus purchased by users to the terminal apparatus manufacturing company, and receives a premium depending on the number of the users receiving the additional information from the user-selected information providing server.

The terminal apparatus may be any one of: a web phone performing a telephone and a web surfing functions through the Internet, a web TV performing a television and the web surfing functions through the Internet, a PDA used for personal or business affairs and having a calculation, an information storing and a searching functions and a cellular phone capable of wireless voice communication and having its own browser.

Further the additional service may have any one of: a bank business service for performing an Internet banking, a stock business service for performing a cyber stock deal, and an insurance business service for performing a business related to an insurance.

Furthermore, an input of the user information and a selection of the information and the additional service are collectively done by a seller selling the terminal apparatus at the time when the user purchases the terminal apparatus, or collectively done at the time when the user initially connects with the user-selected information providing server.

The user information comprises, e.g., sex, age, name, an ID, secret number and address of the user.

To achieve these and other objects in accordance with the principles of the present invention, as embodied and broadly described, the present invention provides an information providing system, comprising: a plurality of terminal units 100, 102, 104 displaying varying visual images to users, said plurality of terminal units 100, 102, 104 including a first terminal unit 100 displaying varying visual images to a first user 100a; a manufacturing unit 700 manufacturing said plurality of terminal units 100, 102, 104 and distributing said plurality of terminal units 100, 102, 104; a first unit 600 providing first services 508 to users who register to receive said first services 508, the first user 100a being registered to receive said first services 508; and a second unit 300 being electrically connected to said first unit 600 through Internet connections 200; said second unit 300 supplying second services 510 to said first terminal unit 100, the first user 100a supplying a first remuneration to said second unit 300 in exchange for said second services 510, said first terminal unit 100 receiving said second services 510 from said second unit 300 by connecting with said second unit 300 through Internet connections 200; said second services 510 including first data 504, second data 506, and said first services 508, said second services 510 being supplied to said first terminal unit 100 in dependence upon third data 502, said third data 502 being provided by the first user 100a; said second unit 300 providing a second remuneration to said manufacturing unit 700 in accordance with a quantity of said plurality of terminal units 100, 102, 104 distributed, said second remuneration being increased when said quantity of said plurality of terminal units 100, 102, 104 distributed is increased; said first unit 600 providing a third remuneration to said second unit 300 in accordance with a quantity of users registering to receive said first services 508, said third remuneration being increased when said quantity of users registered to receive said first services 508 is increased.

To achieve these and other objects in accordance with the principles of the present invention, as embodied and broadly described, the present invention provides an information providing system, comprising: a plurality of terminal units 100, 102, 104 displaying varying visual images to users, said plurality of terminal units 100, 102, 104 including a first terminal unit 100 displaying varying visual images to a first user 100a; a manufacturing unit 700 manufacturing said plurality of terminal units 100, 102, 104 and distributing said plurality of terminal units 100, 102, 104; a first unit 600 providing first services 508 to users who register to receive said first services 508, the first user 100a being registered to receive said first services 508; a second unit 300 being connected to said first unit 600; said second unit 300 supplying second services 510 to said first terminal unit 100, said first terminal unit 100 receiving said second services 510 from said second unit 300 by connecting with said second unit 300 through Internet connections 200; and said second services 510 including first data 504 and second data 506 and said first services 508, said second services 510 being supplied to said first terminal unit 100 in dependence upon third data 502, said third data 502 being provided by the first user 100a.

To achieve these and other objects in accordance with the principles of the present invention, as embodied and broadly described, the present invention provides an information providing method, comprising: manufacturing a plurality of terminal units 100, 102, 104 including a first terminal unit 100 at a manufacturing unit 700, and distributing said plurality of terminal units 100, 102, 104; providing first services 508 to users who register to receive said first services 508, said providing of said first services 508 being performed by a first unit 600; registering a first user 100a to receive said first services 508; connecting a second unit 300 to said first unit 600; and supplying second services 510 to said first terminal unit 100 from said second unit 300, said first terminal unit 100 receiving said second services 510 from said second unit 300 by connecting with said second unit 300 through Internet connections 200, said second services 510 including first data 504 and second data 506 and said first services 508, said second services 510 being supplied to said first terminal unit 100 in dependence upon third data 502, said third data 502 being provided by the first user 100a.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a view showing an Internet service system for providing a user-selected information, in accordance with the principles of the present invention;

FIG. 2 is a view showing a user-selected information providing server in the Internet service systems for providing the user-selected information, in accordance with the principles of the present invention;

FIG. 3 is a view showing a client in the Internet service systems for providing the user-selected information, in accordance with the principles of the present invention; and

FIG. 4 is a flow chart showing the process of the Internet service system for providing the user-selected information, in accordance with the principles of the present invention.

### DETAILED DESCRIPTION OF THE PREFERRED EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

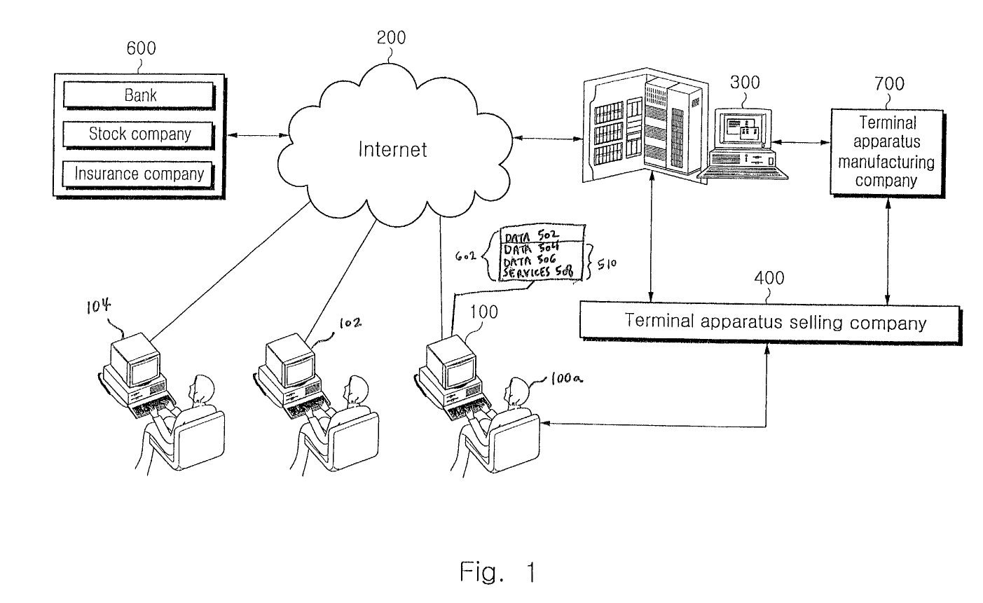

FIG. 1 shows a first unit 600, the Internet 200, a second unit 300, a manufacturing unit 700, a selling unit 400, a first user 100a, a first terminal unit 100, other terminal units 102 and 104, data 502, data 504, data 506, and first services 508. The data 502, data 504, data 506, and first services 508 all grouped together form 510. The data 504 and data 506 and first services 508 all grouped together form second services 510.

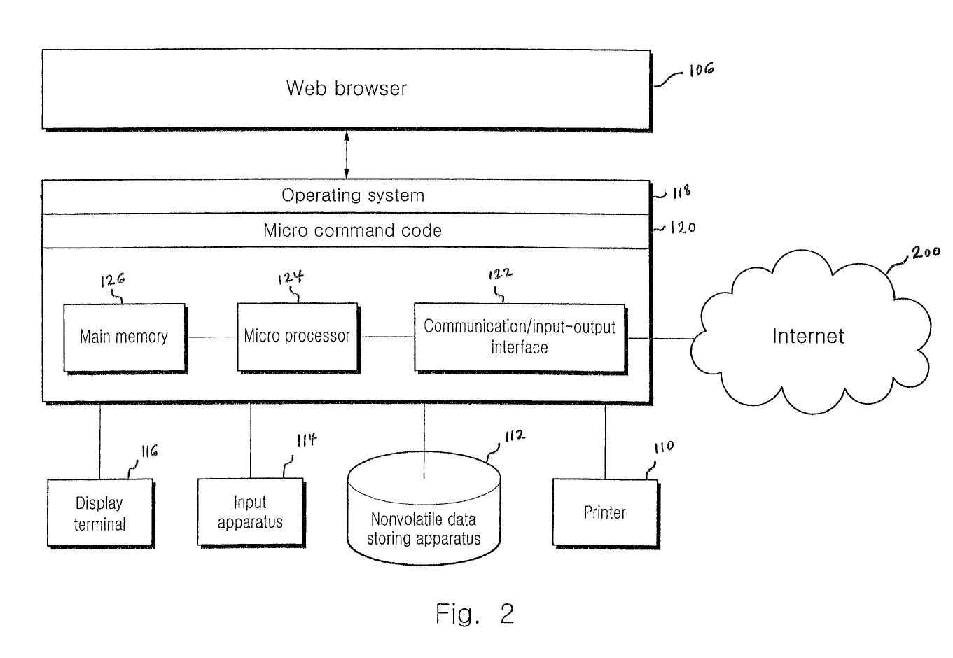

FIG. 2 shows a web browser 106, an operating system 118, micro command code 120, main memory 126, a microprocessor 124, a communication input output interface 122, the Internet 200, a printer 110, a nonvolatile data storing apparatus 112, an input apparatus 114, and a display terminal 116.

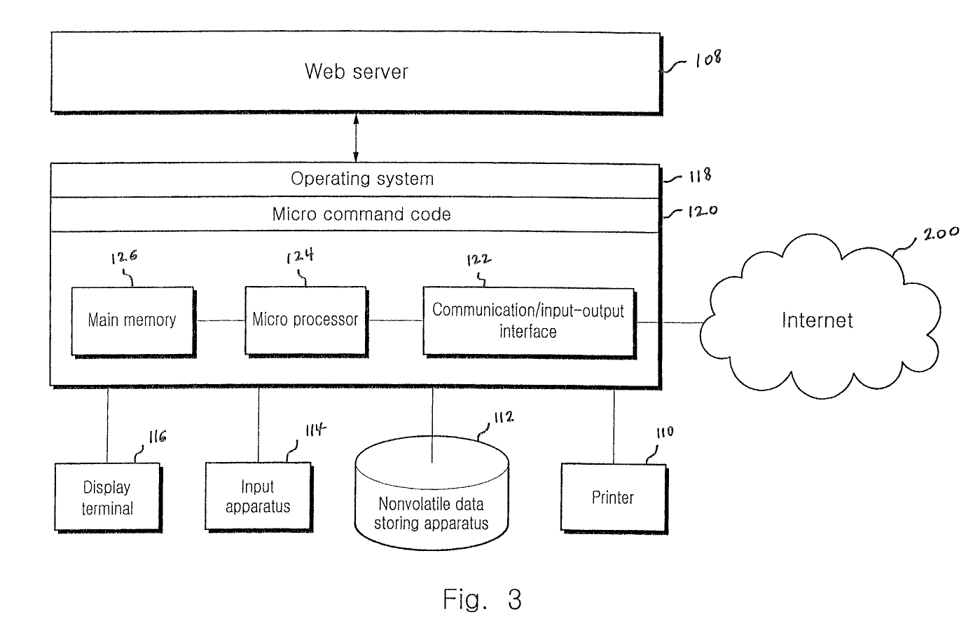

FIG. 3 shows a web server 108, an operating system 118, micro command code 120, main memory 126, a microprocessor 124, a communication input output interface 122, the Internet 200, a printer 110, a nonvolatile data storing apparatus 112, an input apparatus 114, and a display terminal 116.

The present invention is herein described with reference to information and services. The information and services are symbolically shown in FIG. 1 identified with the reference numeral 602.

The “user information” described in conjunction with the present invention corresponds to data 502 and can include items such as name, date of birth, password, address, gender, and other information about a user 100a. Other data could be included in data 502. This is just a sample list. Data 502 is shown in FIG. 1.

The “basic information” described in conjunction with the present invention corresponds to data 504 and can include items such as weather, local news, national news, and international news, a horoscope, and a fortune. This data 504 can be automatically generated in accordance with the data 502 described above. In other words, the address of the user 100a is included in data 502, and thus the weather for the region including that address can be generated. The weather, in this instance, falls in the category of “basic information” and is also described as data 504. Other information could be included in data 504. This is just a sample list. Data 504 is shown in FIG. 1.

The “user-selected information” described in conjunction with the present invention corresponds to data 506 and can include categories of information that are of particular interest to the user 100a. For example, the following categories can be selected by user 100a to be included in data 506: politics, economics, society, culture, sports, games, and computers. Other categories could be included in data 506. This is just a sample list. Data 506 is shown in FIG. 1.

The “additional services” described in conjunction with the present invention correspond to services 508 and can include Internet banking services, Internet stock trading services, insurance-related services, and others. Other types of services could be included in services 508. This is just a sample list. Services 508 are shown in FIG. 1. The data 504, data 506, and services 508 can be grouped together to form second services 510. Services 510 are shown in FIG. 1.

FIG. 1 is a view of an Internet service system for providing a user-selected information according to a present invention. FIG. 2 is a view of a user-selected information providing server according to the present invention. FIG. 3 is a view of a user terminal apparatus according to the present invention.

As shown in the drawings, a terminal apparatus manufacturing company 700 cooperates with a user-selected information providing company 300 in their business, and sells a terminal apparatus to a user 100a through a terminal apparatus selling company 400. An apparatus utilized through the Internet, such as a web phone, a web TV, a personal digital assistants (PDA) and a cellular phone, can be used as the terminal apparatus 100. The terminal apparatus manufacturing company 700 can manufacture an exclusive terminal apparatus with a display according to a display information provided by the user-selected information providing company 300 depending on the demand of the company 300. The user 100a buys the terminal unit 100 from company 400 and pays a remuneration (such as cash, for example) to company 400. Remuneration can be cash, credit, a gift of services, another type of gift, a promise to pay, a promise to provide payment or services, a discounted price for goods or services, or other type of compensation.

The information from the user-selected information providing company 300 linked to the Internet 200 can be provided to the user via the terminal apparatus 100. The provided information is determined by the selection of the user 100a. In other words, the user selects which information is to be provided to the user. In order to select the information to be provided, the user makes a request at the time the user purchases the terminal apparatus 100, or the user makes a request after the user purchases the terminal apparatus 100. If the user makes the request after the user purchases the terminal apparatus 100, then the request is made by connecting with a web server of the user-selected information providing company 300, which will be described hereinafter.

Further, the user-selected information providing company 300 receives additional service information from additional service companies 600, such as a bank, a stock company, an insurance company and the like, through the Internet 200. At this moment, a procedure for selecting a desired additional service according to the additional service companies 600 needs to be prepared in the user-selected information providing company 300 because there are many kinds of additional service companies 600.

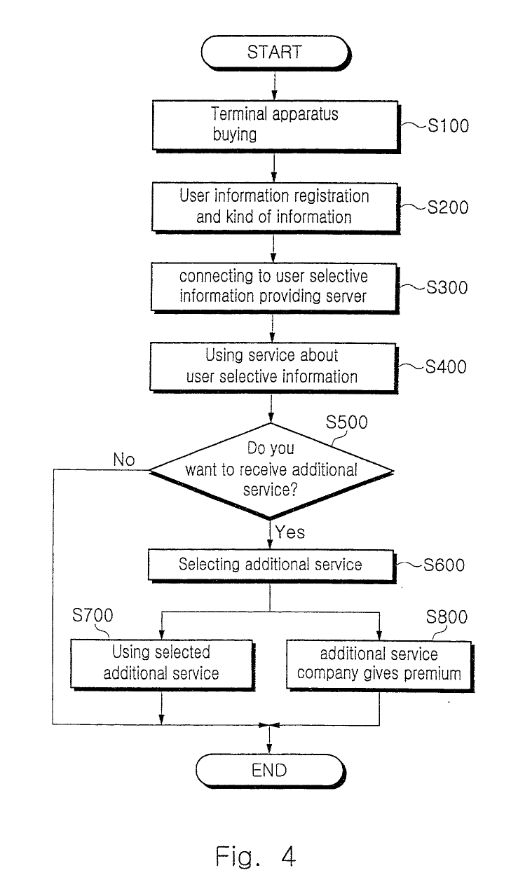

Referring to FIGS. 1 and 4, a user-selected information providing method employed to the system of the present invention will now be described in detail.

In FIG. 4, at step S100, the user 100a purchases the terminal apparatus connectable to the user-selected information providing company 300 through Internet 200 from the terminal apparatus selling company 400. The terminal apparatus selling company 400 may sell or distribute the terminal apparatus through an agency of the terminal apparatus manufacturing company 700 or a branch office of the user-selected information providing company 300. In both cases, the user-selected information providing company 300 gives a premium depending on the number of the sold terminal apparatus to the terminal apparatuses manufacturing company 700. This premium lessens the manufacturing cost of the terminal apparatus, as stated below. Therefore, the burden of the user is reduced. The premium is a type of bonus or discount. This premium could be a cash bonus. This premium could be described as a remuneration.

The terminal apparatus 100, as mentioned above, may be any one of a web phone capable of wire/wireless networking and performing a telephone function and a web surfing function through Internet, a web TV performing a television function and a web surfing function through Internet, the PDA used for personal or business affairs and having a calculation, an information storing and a searching functions, or a personal communications services(PCS) phone and the cellular phone capable of wireless voice communication and having their own browsers, respectively.

Preferably, the terminal apparatus can have a display generator for generating an optimum display considering, e.g., its resolution, corresponding to a display information received from the user-selected information providing company 300. Thus, the resolution of terminal 100 can be automatically adjusted in accordance with data from company 300. Thus, the resolution of terminal 100 can be automatically adjusted in accordance with data from company 300.

In FIG. 4, at step S200, further, as mentioned above, the user inputs and registers a user information, and then selects the kind of information which he wants to obtain. In order to select the kind of information, at the time when purchasing the terminal apparatus, the user may select the kind of information which he wants to obtain, and submit to the terminal apparatus selling company 400 a request form on which the selected information is written. The terminal apparatus selling company 400 periodically sends the written request forms to the user-selected information providing company 300 and registers the selected information. Further, in another method, it is possible for the user to directly connect with the user-selected information providing company 300 through the terminal to select the kind of information which he wants to obtain.

As stated above, upon the registration via the written request or on-line, the user inputs the user information. The user information may includes gender, age, name, identification is number (ID), secret number, social security number, and address of the user 100a.

Further, the information which the user wants to obtain can be divided into a basic information and a user-selected information. The basic information on the basis of the user information inputted by the user 100a upon the registration has a weather information where the user resides, a synthetic stock information, a local/national/international headline news of the date, a horoscope or fortune of the date for the user and the like. On the other hand, the user-selected information can be selected in the categories such as a politics, an economy, a society, a culture, a sport, a game and a computer, which are set by the user-selected information providing company 300.

In FIG. 4, at step S300, after these processes are completed, if the user 100a connects with the user-selected information providing company 300 through Internet 200, the user-selected information providing company 300 determines through a user confirmation service whether or not the user 100a is already registered to the user-selected information providing company 300.

At step S400, if it is determined that the user is registered, the basic information and a previously selected information are provided to the user by the user-selected information providing company 300.

For example, the information of the user(100) are as follows:

1) sex: male,

2) name: Hong, Gil-dong,

3) age: 29,

4) ID: jaionet,

5) secret number: bigbang, and

6) address: 2nd Floor, Pyeongchang B/D, 44-2 Bang-i Dong, Songpa Ku, Seoul, Korea.

In this case, if the user 100a connect with the Web server of the user-selected information providing company 300, the following information:

1) the weather in Seoul,

2) the fortune of the date about the 29 years old persons who were born in the Year of the Mouse,

3) the information of the synthetic stock number, and

4) the information of the internal/international headline news of the date is provided as the basic information through the terminal of the user 100a. Further, the information on the categories such as a politics, an economy, a culture, a game, and a sport, selected by the user himself, are provided.

In FIG. 4, at step S500, further, the user decides whether to receive the additional services provided by the additional service companies 600 linked to the user-selected information providing company 300. Then, at step S600, the user selects an additional service of the desired additional service company 600. At step S700, the user utilizes the selected additional service.

The additional service includes a bank business service for performing an Internet banking, a stock business service for performing a cyber stock deal, an insurance business service for performing a business related to an insurance and the like.

Further, at step S800, the additional service companies 600 may give a premium depending on the number of members who registered in order to receive the additional services of the companies 600 to the user-selected information providing company 300. The user-selected information providing company could provide good contents to the user.

On the other hand, while the user may register to the additional service company 600, as mentioned above, via the user-selected information providing company 300, the user may submit a written request form for registration upon the purchase of the terminal apparatus. The terminal apparatus selling company 400 gathers these requests and sends them to the user-selected information providing company 300, and the user-selected information providing company 300 handles all the requests for registration.

Although the invention has been shown and described with respect to the preferred embodiment according to the present invention, it will be understood by those skilled in the art that various changes and modifications may be made without departing from the spirit and scope of the invention as defined in the following claims. Therefore, other embodiments changed from the present embodiment would not be inconsistent with the principles of the present invention.

As mentioned above, according to the present invention, the user-selected information providing company gives a premium depending on the number of the sold terminal apparatus to the terminal apparatus manufacturing company. This premium lessens the manufacturing cost of the terminal apparatus. Therefore, the burden of the user is lowered.

Further, the terminal apparatus manufacturing company can reduce the cost by means of mass production. Therefore, a large market for the terminal apparatus can be formed due to the reduced cost thereof. Further, an advertisement for the apparatus through a cooperative marketing with the associated companies can be maximized. Furthermore, the distribution cost is reduced by providing a package of the terminal apparatus itself and its service to the user, thereby resulting in the decreased price thereof.

Further, the user can conveniently obtain the terminal apparatus in lower price and a package of the terminal apparatus and its service.

The foregoing paragraphs describe the details of an information providing system through Internet; and, more particularly, describe the details of a system for quickly providing only the information which a user selected among basic informations and for providing only the additional services which the user selected and demanded to additional service companies, such as a security company, a bank and an insurance company, linked to the user-selected information providing server.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. An information providing system, comprising:
a plurality of terminal units displaying varying visual images to users, said plurality of terminal units including a first terminal unit displaying varying visual images to a first user;
a manufacturing unit manufacturing said plurality of terminal units and distributing said plurality of terminal units;
a first unit providing first services to users who register to receive said first services, the first user being registered to receive said first services; and
a second unit being electrically connected to said first unit through Internet connections;
said second unit supplying second services to said first terminal unit, the first user supplying a first remuneration to said second unit in exchange for said second services, said first terminal unit receiving said second services from said second unit by connecting with said second unit through Internet connections;
said second services including first data, second data, and said first services, said second services being supplied to said first terminal unit in dependence upon third data, said third data being provided by the first user;
said second unit providing a second remuneration to said manufacturing unit in accordance with a quantity of said plurality of terminal units distributed, said second remuneration being increased when said quantity of said plurality of terminal units distributed is increased;
said first unit providing a third remuneration to said second unit in accordance with a quantity of users registering to receive said first services, said third remuneration being increased when said quantity of users registered to receive said first services is increased.

2. The system of claim 1, said third data corresponding to at least one item of information selected from among legal name of the first user, address of the first user, date of birth of the first user, user name selected by the first user, password of the first user, gender of the first user, age of the first user, and identification number of the first user.

3. The system of claim 2, said first data corresponding to at least one category of information selected from among weather, news, and horoscope.

4. The system of claim 3, said second data corresponding to at least one category of information selected from among politics, economics, society, culture, sports, games, and computers.

5. The system of claim 4, said first services corresponding to at least one category of services selected from among bank business services for performing Internet banking, securities services for performing Internet stock trading services, insurance business services for performing insurance-related business.

6. The system of claim 1, said first terminal unit further comprising at least one unit selected from among a web phone performing telephone and web surfing functions through Internet connections, a web television performing television and web surfing functions through Internet connections, a personal digital assistant having calculation functions, and information storing and searching functions, and a cellular phone having wireless voice communication and having its own Internet browser.

7. The system of claim 6, said personal digital assistant being used for at least one function selected from among personal functions and business functions.

8. The system of claim 1, said third data being recorded when the first user receives said first terminal unit.

9. The system of claim 1, further comprising:
a selling unit selling said first terminal unit to the first user, said third data being provided from the user to said selling unit when said first terminal unit is sold to the first user.

10. The system of claim 9, said selling unit providing said third data to said second unit.

11. The system of claim 1, further comprising:
a selling unit selling said first terminal unit to the first user, said third data being provided from the user to said selling unit when said first terminal unit is sold to the user, the user selecting said second data and said first services when said first terminal is sold to the first user, said selling unit recording said selection of said second data and said selection of said first services when said first terminal unit is sold to the first user.

12. The system of claim 11, said selling unit providing information related to said selections of said second data and said first services to said second unit.

13. The system of claim 1, said third data being provided from the first user to said second unit when the first user initially connects said first terminal unit with said second unit, the first user selecting said second data and said first services when the first user initially connects said first terminal unit with said second unit.

14. An information providing system, comprising:
a plurality of terminal units displaying varying visual images to users, said plurality of terminal units including a first terminal unit displaying varying visual images to a first user;
a manufacturing unit manufacturing said plurality of terminal units and distributing said plurality of terminal units;
a first unit providing first services to users who register to receive said first services, the first user being registered to receive said first services;
a second unit being connected to said first unit;
said second unit supplying second services to said first terminal unit, said first terminal unit receiving said second services from said second unit by connecting with said second unit through Internet connections; and
said second services including first data and second data and said first services, said second services being supplied to said first terminal unit in dependence upon third data, said third data being provided by the first user.

15. The system of claim 14, the first user supplying a remuneration to said second unit in exchange for said second services.

16. The system of claim 14, said second unit being connected to said first unit by Internet connections.

17. The system of claim 14, said second unit providing a remuneration to said manufacturing unit in accordance with a quantity of said plurality of terminal units distributed, said remuneration being increased when said quantity of said plurality of terminal units distributed is increased.

18. The system of claim 14, said first unit providing a remuneration to said second unit in accordance with a quantity of users registering to receive said first services, said remuneration being increased when said quantity of users registered to receive said first services is increased.

19. An information providing method, comprising:
manufacturing a plurality of terminal units including a first terminal unit at a manufacturing unit, and distributing said plurality of terminal units;
providing first services to users who register to receive said first services, said providing of said first services being performed by a first unit;
registering a first user to receive said first services;
connecting a second unit to said first unit; and
supplying second services to said first terminal unit from said second unit, said first terminal unit receiving said second services from said second unit by connecting with said second unit through Internet connections, said second services including first data and second data and said first services, said second services being supplied to said first terminal unit in dependence upon third data, said third data being provided by the first user.

20. The method of claim 19, further comprising:
providing a first remuneration to said manufacturing unit in accordance with a quantity of said plurality of terminal units distributed, said first remuneration being increased when said quantity of said plurality of terminal units distributed is increased, said first remuneration being provided to said manufacturing unit by said second unit; and
providing a second remuneration to said second unit in accordance with a quantity of users registering to receive said first services, said second remuneration being increased when said quantity of users registered to receive said first services is increased, said second remuneration being provided to said second unit by said first unit.
